(19) United States
(12) Patent Application Publication
(10) Pub. No.: US 2011/0305497 A1
(43) Pub. Date: Dec. 15, 2011

(54) Flexible air pump with stand-alone diaphragm valve

(76) Inventor: George Pappageorge, Englewood Cliffs, NJ (US)

(21) Appl. No.: 13/134,632

(22) Filed: Jun. 10, 2011

Related U.S. Application Data
(60) Provisional application No. 61/397,379, filed on Jun. 10, 2010.

(51) Int. Cl. B43K 7/10; F16K 7/00

(52) U.S. Cl. 401/185; 251/331

(57) ABSTRACT

A widely used marking pen for dispensing viscous substances comprises: a casing with a dispensing tip, a ball being spring biased to selectively reveal a dispensing tip orifice that permits pressurized flow therefrom, a flexible bulb member with orifice therein permitting repeatable finger actuated pressurization of the casing interior, and a valve positioned between the liquid/semi-paste substance and the flexible bulb member. The valve maintains, on the downstream side, air under pressure to ensure good flow of the substance. The invention herein offers improvements over such valves by reducing the number of parts that are commonly used, thereby reducing complexity of its assembly, while offering improved results in terms of the longevity in maintaining pressure within the casing. The valve may comprise a stand-alone diaphragm with a specially contoured and resilient diaphragm wall having a self-sealing slit therein that independently permits pressurized fluid flow in only the desired direction.

### CROSS REFERENCES TO RELATED APPLICATIONS

This application claims priority on U.S. Provisional Application Ser. No. 61/397,379 filed on Jun. 10, 2010, having the title, “Flexible Air Pump with Integral Valve,” the disclosures of which are incorporated herein by reference.

### FIELD OF THE INVENTION

The present invention relates to air pumps which are finger operated, and more particularly to improvements in the diaphragm-type valve arrangements typically found therein.

### BACKGROUND OF THE INVENTION

At the present time, one widely used type of marking pen for dispensing of a highly viscous substance (ink, paint, etc.) for home decoration on fabrics, or industrial markings on fabric or metal plates or other materials, comprises a pump means and a valve arrangement. These marking pens utilize some means of pumping because the viscosity of the product to be dispensed is too excessive for simple gravity-induced flow. Therefore, air pressure is applied to the substance within the casing of the marking pen to facilitate dispensing from an applicator tip.

In one particular style of these marking pens, the substance may be applied and/or spread on the receiving surface by a ball which is part of a one-way valve mechanism at the marker's tip. The ball may be biased into a closed position by a helical spring residing within a valve seat. When the user applies the tip of the marking pen to the receiving surface, for example a sheet of metal, the force of contact therebetween causes the ball to counter the spring biasing and move away from a position where it seals against an annular lip at the tip, thus permitting a pressure-induced flow of product from the opening.

Various different means of creating the requisite pressure for flow of the viscous product have been taught, including incorporation into the marker casing of gas cartridges and small air pumps. One highly suitable pump comprises a dome or bulb of rubber or other resilient material that may be flexed through depression by a user's finger. The dome, at its apex, may have an aperture that may be covered by the user's finger, so that air is trapped in the bulb. When the bulb is compressed with the aperture sealed by the finger, the air within the bulb is forced through a one-way air valve that is located between the bulb and the reservoir of the viscous substance in the marker's casing.

One example of this arrangement is shown by U.S. Pat. No. 3,377,124 to De Molin for a “Valve Construction for Pressurized Fluid Dispensers.” The De Molin device requires an upper valve member in the form of a metallic disk with a non-concentric orifice, and a deformable lower valve member with a centrally disposed slit, where both are assembled into a valve casing. In De Molin's arrangement, depressing the bulb introduces air that proceeds through the orifice of the upper disk and causes a distension of the lower disk, which causes the slit to open to permit the passage of air therethrough. When the finger is removed from the bulb, the air pressure now within the reservoir will then counter the distension of the lower valve member, but the member will be prevented from distending upwardly because of its contact with the solid central portion of the upper valve disk member, thus prohibiting equalization of pressure from the reservoir. The drawback of De Molin is that it requires the manufacture, careful assembly, and interaction of three separate members to enable its use.

In U.S. Pat. No. 4,646,945 to Steiner for “Vented Discharge Assembly for Liquid Soap Dispenser,” two similar valve disk members are utilized, but are seated on a flange of the nipple, eliminating one of the parts required by De Molin. U.S. Pat. No. 5,000,745 to Guest for a “Hemostasis Valve” provides for analogous functionality and incorporates “at least three elastic membranes” to permit catheter insertion and removal into a blood lumen without any blood loss therefrom.

Although these devices may have been proven to operate satisfactorily for many years, the arrangements are complex and relatively expensive due to the number of parts and the required assembly process, for which, in De Molin, the disclosure suggests “using a separate station for positioning of each of the elements.” The invention disclosed herein eliminates this multiplicity of parts and the intricacy of assembly, to thereby reduce cost and save assembly time, while procuring results that furthermore represent an improvement over the prior, in that the arrangement disclosed herein additionally is capable of holding pressure for an unprecedented amount of time.

### OBJECTS OF THE INVENTION

It is an objective of the invention to provide a one-way valve being capable of transmitting air from a finger-operated air pump, and having relatively few components for ease of assembly, while being relatively low in manufacturing cost.

It is a further objective of the present invention to provide such valves for use in a marking pen, which valve is highly reliable in use; is not adversely affected by the liquid paint or other substance in the marking pen; and operates satisfactorily even after the pen has been stored for a prolonged period of time.

It is a feature of the present invention to provide a valve in a marking pen having a casing, which forms a liquid reservoir, to permit one-way air flow for sufficient pressurization being suited to force flow of a liquid having a viscosity in the range of 1200 to 10,000 centipoises.

Further objects and advantages of the invention will become apparent from the following description and claims, and from the accompanying drawings.

### SUMMARY OF THE INVENTION

A hand-held marking pen for applying a liquid, semi-liquid, or semi-paste substance onto a surface may comprise: a hollow casing with a dispensing orifice at one end; a ball being spring biased within the casing to selectively block the dispensing orifice; a flexible bulb member with an orifice therein, permitting finger actuated pressurization of an interior of the casing; and a valve being positioned between the liquid or semi-paste substance and the flexible bulb member. The valve may serve to maintain air under pressure on the downstream side of the valve, to ensure good flow of the substance when the ball is moved against the biasing to a distal position during use. The valve of the current invention may be a stand-alone diaphragm valve comprising: a support wall with a cylindrical recess therein and a dome-shaped diaphragm wall having a self-sealing slit therein.

The dome-shaped diaphragm wall may be integrally formed with the support wall and may comprise an outer surface and an inner surface. The outer surface may comprise a truncated spherical surface having an axis being collinear with the axis of the cylindrical recess. The inner surface may comprise a truncated spherical surface having an axis being generally collinear with the axis of the outer surface. The cylindrical recess may therefore terminate on the truncated spherical inner surface. The inner truncated spherical surface is set so as to be non-concentric with the truncated spherical outer surface, to produce thinning of the diaphragm wall at its apex.

The self-sealing slit is formed in the dome-shaped diaphragm wall, and may have a length being generally centered with respect to the axis of the spherical surfaces. The self-sealing slit of the diaphragm valve permits pressurized air flow to generally flow in only one direction—being out through the self-sealing slit from the inner surface to the outer surface. The self-sealing slit of the diaphragm valve generally prohibits air flow in the opposite direction, being in through the self-sealing slit from the outer surface to the inner surface.

The opposite direction flow is generally prohibited by the self-sealing slit because the dome-shaped diaphragm wall on a first side of the slit and the dome-shaped diaphragm wall on a second side of the slit resists the pressure by bearing against each other to accomplish self-sealing of the opening. The pressure on the dome-shaped wall is reacted through compressive hoop stresses within the dome-shaped diaphragm wall.

The thinning of the dome-shaped diaphragm wall produces an opening in the self-sealing slit, during the pressurized flow, creating non-linear displacement along the length of the slit, with maximum displacement occurring in a portion of the slit at its apex. The self-sealing slit being so crafted supports an amount of pressurization being sufficient to force the flow out from the dispensing orifice for a substance having viscosity in the range of approximately 1200 to approximately 10,000 centipoises. With this thinning of the diaphragm wall at the apex being approximately down to 0.015 inches, the self-sealing slit in the diaphragm wall permits the pressurized air flow in through the self-sealing slit from the inner surface to the outer surface for pressures being approximately as low as 0.5 to 1.0 psi, and prohibits undesirable return pressurized air flow through the self-sealing slit from the outer surface to the inner surface for pressures being up to approximately 5 psi to 6 psi. The stand-alone valve herein produces remarkably improved results in terms of resisting the undesirable return pressurized air for a long period of time, giving the marking pen extraordinarily long shelf-life, once pressurized. Testing has shown that the self-sealing slit resists pressure for a period of at least two months.

### BRIEF DESCRIPTION OF THE DRAWINGS

FIG. 1 is a perspective view of a prior art marking device.

FIG. 1A shows an exploded view of the pump and valve portion of the prior art marking device of FIG. 1.

FIG. 2 is a cross-sectional view of the marking pen of the current invention, with a stand-alone diaphragm valve.

FIG. 2A is a cross-sectional view of the marking pen of the current invention, showing the outward deformation and opening of the stand-alone diaphragm valve at the slit, due to pressure generated from the bulb member being deformed.

FIG. 2B is a cross-sectional view of the marking pen of FIG. 2A, showing the load reaction due to hoop compression stress generated by the pressure within the casing, which creates the self-sealing nature of the slit.

FIG. 3 is cross-sectional view of the resilient bulb member of FIG. 2.

FIG. 4 is a cross-sectional view of the stand-alone diaphragm valve of FIG. 2.

FIG. 4A is a top perspective view of the stand-alone diaphragm valve utilized used in the marking pen of FIG. 2.

FIG. 4B is a bottom perspective view of the stand-alone diaphragm valve utilized used in the marking pen of FIG. 3.

FIG. 5 is a cross-sectional view of the casing used in the marking pen of FIG. 2.

FIG. 6 is a cross section view of the marker tip used in the marking pen of FIG. 2, with spherical ball and biasing spring already assembled therein.

FIG. 7 is a cross-sectional view of an alternate embodiment of the marking pen of the current invention, which uses an alternate embodiment of the stand-alone diaphragm valve.

FIG. 8 is a top perspective view of the alternate embodiment stand-alone diaphragm valve utilized used in the marking pen of FIG. 7.

FIG. 9 is a bottom perspective view of the alternate embodiment stand-alone diaphragm valve utilized used in the marking pen of FIG. 7.

FIG. 10 is an enlarged cross-sectional view of the alternate embodiment of the stand-alone diaphragm valve utilized used in the marking pen of FIG. 7.

FIG. 11 is an enlarged cross-sectional view of a second alternate embodiment of the stand-alone diaphragm valve of the current invention.

FIG. 12 is a top view of the second alternate embodiment of the stand-alone diaphragm valve of FIG. 10.

### DETAILED DESCRIPTION OF THE INVENTION

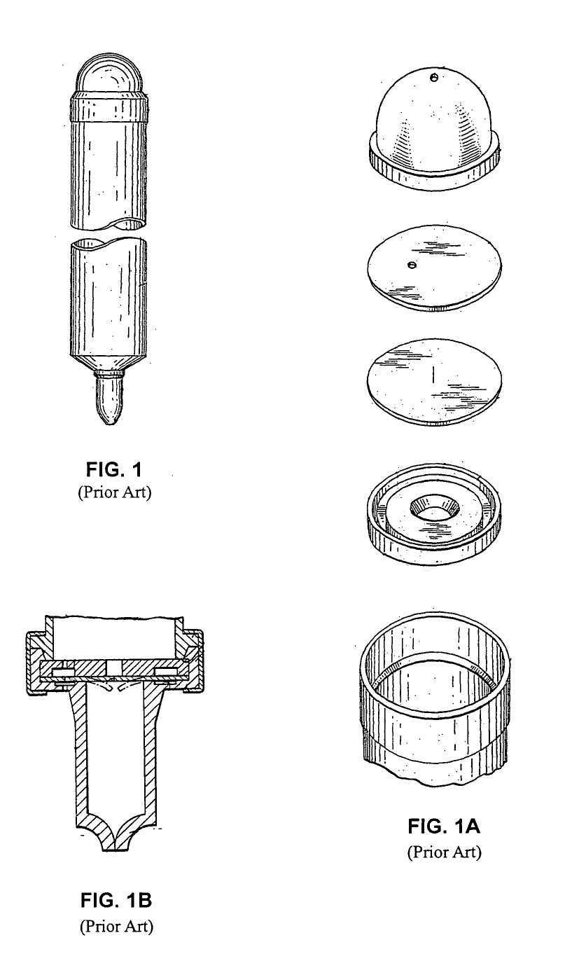

FIG. 1 shows a prior art marking pen that is capable of dispensing substances having high viscosity, and which may be in the form of a liquid, a semi-liquid, or may even be more of a semi-paste, being a substance having a paste-like consistency. FIG. 1A shows a prior art pump in the form of a flexible bulb member with an orifice therein, and a corresponding multi-piece valve to permit one-way directional flow of the air pumped, as a result of a finger covering the bulb's orifice and simultaneously depressing the bulb member. FIG. 1B shows an improved version of a one-way valve for such dispensing devices, and eliminates one part. But both prior art valves, due to the multiplicity of parts, raise the costs of producing the final product, due to manufacturing costs of the additional parts, and due to the more intricate steps that are taken for its assembly.

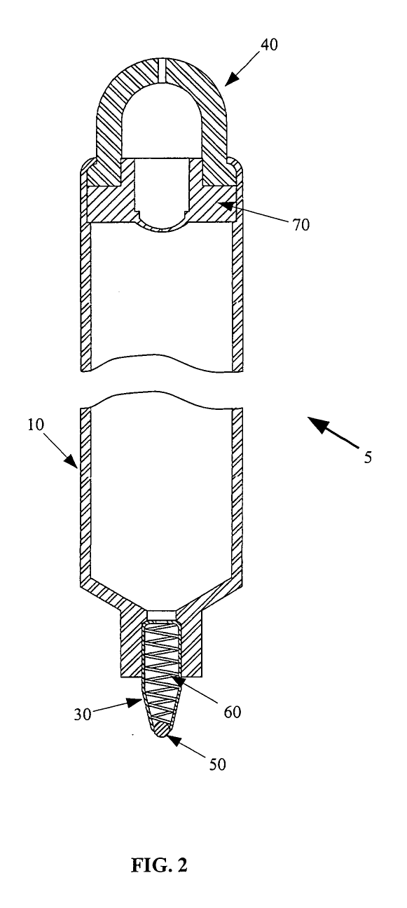

A hand-holdable marking pen 5 of the current invention is shown in the cross-sectional view of FIG. 2, and includes a new, stand-alone, one piece diaphragm valve 60. The valve 60, disclosed herein, not only reduces costs by eliminating extra parts and simplifying the assembly procedure, but additionally achieves improved results in terms of the pressures that may be supported and the duration that those pressures may be sustained within the device by the valve, as the marking pen may be stored for a substantial period of time between uses.

The marking pen 5 of FIG. 2 may comprise a casing 10, a marker tip 30, spherical ball 50, biasing spring 60, resilient bulb member 40, and a stand-alone diaphragm valve 70. The casing 10, as seen in detail in FIG. 5, may have a first end 11, and a second end 12, and may preferably be in the form of a hollow elongated cylinder. The casing may be made of metal or a suitable plastic, depending upon the particular use. The casing 10 may transition, at the second end 12, using a conical section 14, into a smaller diameter cylinder 15. The cylinder 15 at the second end 12 may have an orifice 17 therein that may terminate before reaching the conical section 14. However, a smaller diameter orifice 16 may interconnect the orifice 17 with the interior cavity 20 of the casing 10. The orifice 17 of the cylinder 15 of casing 10 may receive the marker tip 30.

The casing 10, at the first end 11, may have a rounded lip 13. The first end 11 of casing 10 may also have a large orifice 21 that opens into the interior cavity 20. In a location proximate to the first end 11 of the casing 10, the casing's cylindrical interior surface 18 may step outward to a larger diameter surface 18A to thereby form a shoulder 19. The interior surface 13A of the rounded lip 13 and the shoulder 19 may serve to trap therebetween, the flexible bulb member 40 and the unidirectional stand-alone diaphragm valve 40 of the present invention.

Marker tip 30, seen in FIG. 6, may be made of plastic; however, for many types of surfaces receiving the product, particularly for applications on metal, the marker tip may preferably be made of metal. Marker tip 30 may comprise a hollow cylinder portion 31 that may transition into a conical portion 32. The end of the conical portion 32 may terminate to form an opening 33 into the hollow portion of the marker tip. At the other end of the marker tip, the cylindrical portion may have an orifice 34, so that when the marker tip 30 is installed and operable within the casing 10 of marking pen 5, the substance contained within the interior 20 of the casing 10 may flow through the orifice 16 in the casing and the orifice 34 of the marker tip to form a reservoir of the substance within the marker tip. The hollow interior of the marker tip 30 may receive a spherical ball 50 that may serve to selectively plug the opening 33, and it may be biased into plugging the opening by a helical spring 55 that may be seated therein. When the marking pen 5 is to be used to apply the viscous liquid or past-like substance onto a surface, the marking pen may be held in the user's hand so that the spherical ball 50 is pressed against the surface. This ball-to-receiving-surface contact serves to counter the spring biasing, and moves the ball from a position proximal to and blocking the orifice, to a position distal from the orifice, to thereby permit flow of the substance out from the orifice and onto the receiving surface.

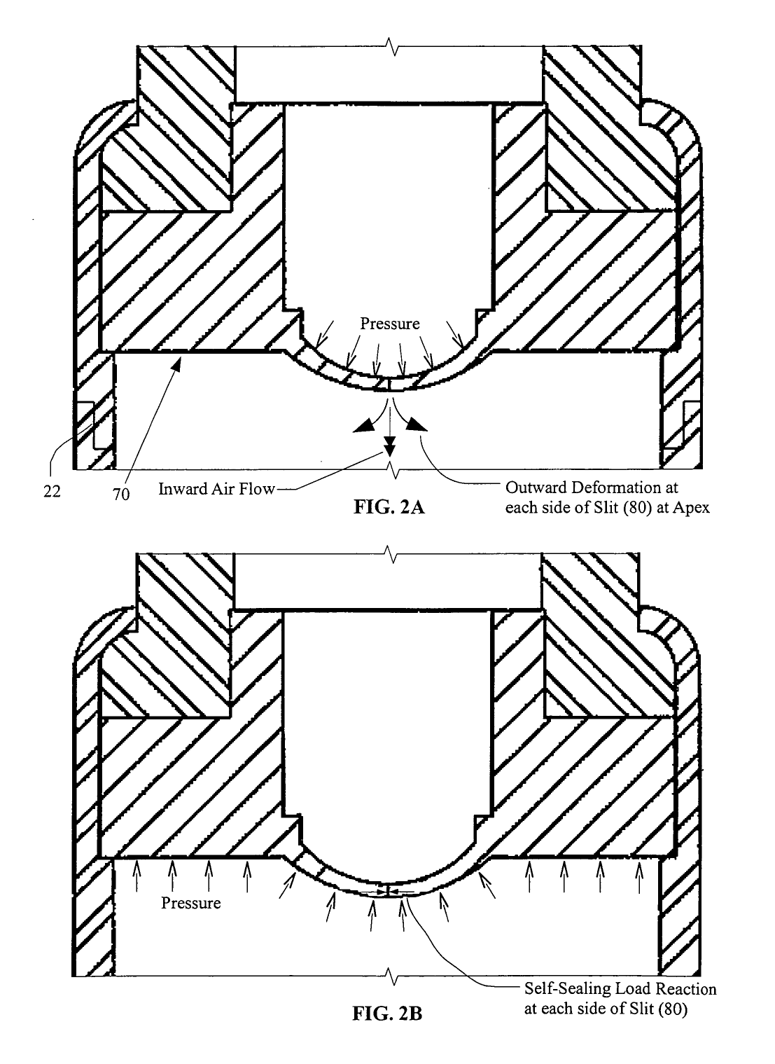

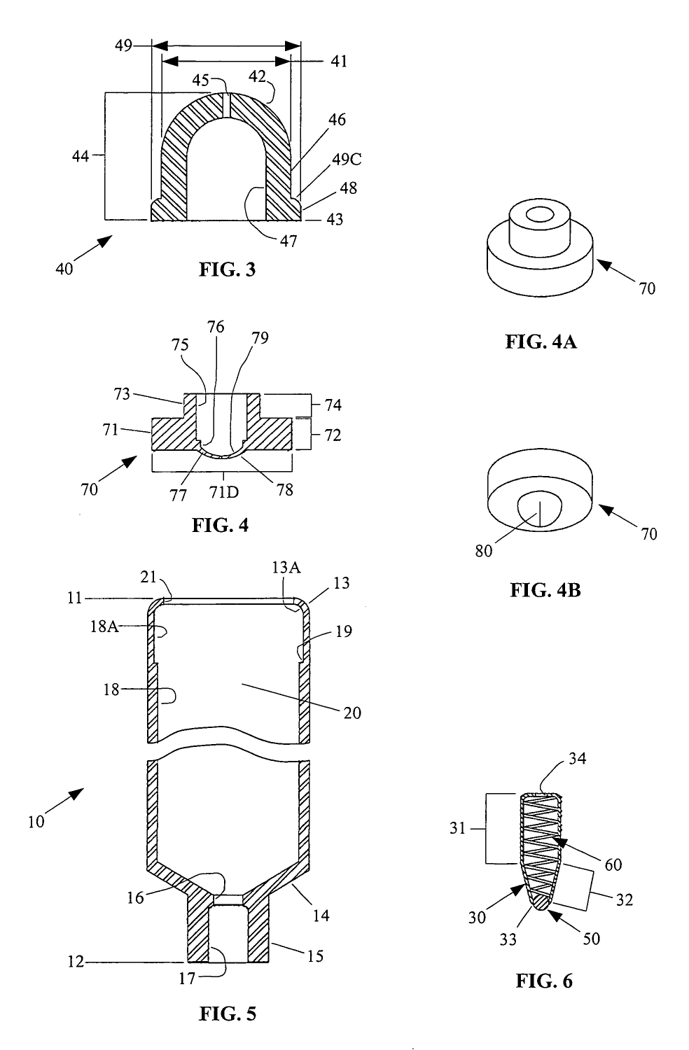

The bulb member 40 may be comprised of a resilient material in order to be able to deform, to accomplish the pumping action required for operation of the marking pen 5. The bulb member 40 may, as seen in FIG. 3, comprise a cylindrical portion with an interior surface 47, and an exterior surface 46 having a diameter 41. The cylindrical portion may transition into a spherical end cap 42, which may have an orifice 45 therein, that may permit the flow of air into the interior of the flexible bulb 40. The flexible bulb member 40 may have a total height 44 above its base 43 to provide a desired amount of air to be pumped into the casing interior 20. A greater total height 44 may permit more air to be pumped in a single stroke, the need for which may depend upon the volume of the interior cavity 20 of the casing, as well as upon the degree of viscosity of the substance contained therein. The flexible bulb member 40 may also have, at the base 43, an annular protrusion 48 with a diameter 49. The upper portion of the annular protrusion may have a cornered edge 49C.

As seen in FIGS. 4, 4A, and 4B, the stand-alone diaphragm valve 70 may comprise a cylindrical support wall 71 of thickness 72 and diameter 71D. Protruding upward in FIG. 4 from cylindrical support wall 71 may be a secondary cylinder 73 that may extend a height or distance 74 away from the support wall. The secondary cylinder 73 may be concentric with the cylindrical support wall 71. An orifice 75 in the secondary cylinder 73 may penetrate to a depth being part-way into the thickness 72 of the of cylindrical support wall 71. A smaller diameter orifice 76 may penetrate to an even greater depth. Both the orifice 75 and the orifice 76 may be concentric with the cylindrical support wall 71.

Protruding downward in that figure from cylindrical support wall 71 may be a protrusion forming a truncated spherical surface 78, having an axis that is collinear with the axis of the cylindrical support wall 74. The opening created by the smaller diameter orifice 76 may extend further into the support wall 71 to form an inner truncated spherical surface 79 having an axis being generally collinear with the axis of the outer surface 78, to form a generally dome-shaped diaphragm wall 77. A self-sealing slit 80, as seen in FIG. 4B, may be formed in the generally dome-shaped wall 77. The precise placement of these features comprise critical aspects of the invention that when so particularly arranged, enable the improved performance characteristics of the stand-alone diaphragm valve 70, while simultaneously eliminating the additional parts that were necessary for operation of the prior art valves. For proper enablement, these features require and receive additional teachings that are disclosed in later paragraphs.

The stand-alone diaphragm valve 70 may be formed of a resilient material, and may be a thermoplastic elastomer such as a DuPont Hytrel (for use with water based substances or paints), or an ethylene homopolymer, or an ethylene copolymer. Ethylene homopolymers include high density polyethylene (“HDPE”) and low density polyethylene (“LDPE”), which may be suitably used for alcohol based substances or paints. Ethylene copolymers include ethylene/alpha-olefin copolymer (“EAO”) and ethylene/unsaturated ester copolymer. EAOs are copolymers of ethylene and one or more alpha-olefins, the copolymer having ethylene content as the majority mole-percentage content. The co-monomer alpha-olefin may be selected from one or more of any of the C₃-C₂₀ α-olefins, such as the C₄-C₁₂ α-olefins, the C₄-C₈ α-olefins, 1-butene, 1-hexene, and 1-octene. EAOs include one or more of the following:

1) medium density polyethylene (“MDPE”), for example having a density of from 0.926 to 0.94 g/cm³;

2) linear medium density polyethylene (“LMDPE”), for example having a density of from 0.926 to 0.94 g/cm³; 3) linear low density polyethylene (“LLDPE”), for example having a density of from 0.915 to 0.930 g/cm³; 4) very-low or ultra-low density polyethylene (“VLDPE” and “ULDPE”), for example having density below 0.915 g/cm³, and 5) homogeneous EAOs.

Preferably, the density of the EAO does not go below 0.890 g/cm³, and more preferably it does not go below 0.900 g/cm³.

As seen in FIG. 2, the resilient bulb member 40 and stand-alone diaphragm valve 70 may be assembly together so that the secondary cylinder 73 of the valve may be received in the interior surface 47 of the bulb member, with the base 43 of the bulb member 40 being in contact with the support wall 71 of the valve. The assembled bulb member 40 and stand-alone diaphragm valve 70 may be anchored within the casing 10, between the interior surface 13A of the rounded lip 13, and the shoulder 19, as described previously. This arrangement with the diaphragm valve 70 located as shown, serves to create a selective barrier between two chambers, with the first chamber being formed on one side of the valve by the interior surface 47 of the bulb member 40, and the second chamber being formed basically by the interior cavity 20 of the casing 10. This selective barrier of the diaphragm valve is specially constructed to accommodate differences in pressure between the two chambers, one of which will contain the liquid or semi-paste substance that is to be applied from marker tip 30. Therefore, the valve being so positioned and so operable between the liquid or semi-paste substance and the flexible bulb member, serves to maintain air under pressure on the downstream side of the valve to ensure good flow of the substance when the ball 50 is moved against the biasing of spring 60 to the distal position during use.

A finger of the user may initially cover the orifice 45 of the bulb member 40, and may thereafter apply pressure to the bulb to cause it to deform inwardly. This decrease in volume within the cavity formed by interior surface 47 of the bulb results in the forcing of air contained therein, through the self-sealing slit 80 of the valve 70, as seen in FIG. 2A. Subsequent releasing of pressure from the user's finger will permit air to flow within the interior of the bulb 40 through orifice 45, to allow the resilient bulb member to naturally return back to its original form. The diaphragm valve 70 thus permits pressurized air to flow in one direction, being out through the self-sealing slit from the inner surface 79 to the outer surface 78, and the nature and construction of the self-sealing slit of the diaphragm valve generally prohibits pressurized air from flowing in the opposite direction, being in through the self-sealing slit 80 from the outer surface 78 to the inner surface 79.

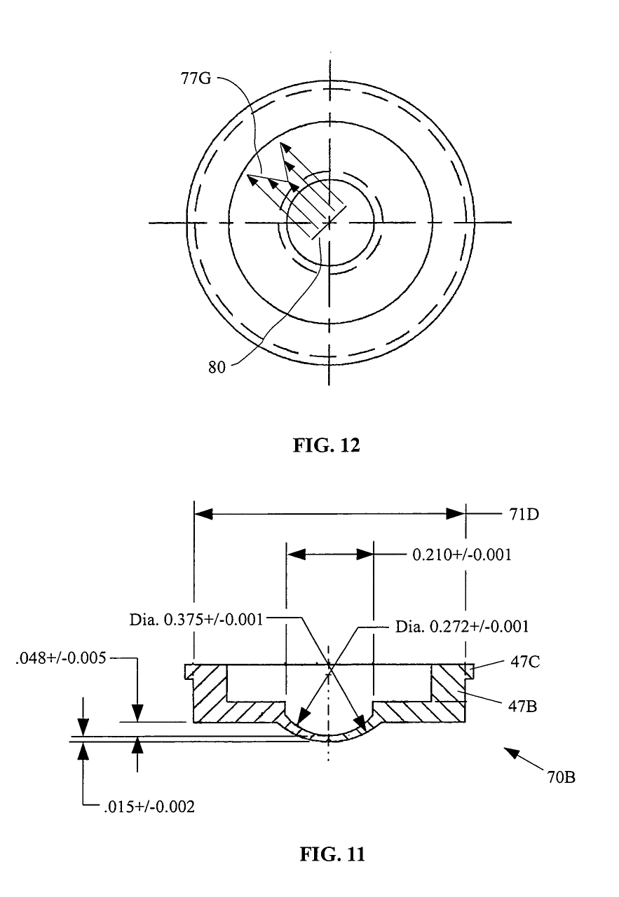

To operate as previously described, and in accordance with other requirements disclosed hereinafter, the diaphragm wall 77 of the stand-alone diaphragm valve 70 needs to be specially formed, with certain of those details being illustrated in FIGS. 10 and 11. As seen in FIG. 10, the outer truncated spherical surface 78 may be formed to an appropriate size, which in this instance, where the diameter 71D of the cylindrical support wall 71 is 0.690± inches, may correspondingly be a 0.375±0.001 inch diameter sphere. The inner surface 79 may be formed to be a 0.273±0.0001 inch diameter sphere, and while it may have its axis being collinear with the axis of the outer surface 78, the inner truncated spherical surface is not concentric thereto, as concentricity would result in a constant wall thickness of 0.375−0.272=0.103 inches. However, as seen in FIG. 11, the inner truncated spherical surface 79 is positioned closer to the outer surface 78 to result in a wall thickness that varies across the dome-shaped diaphragm wall 77. As illustrated graphically in FIG. 12, the wall thickness gradient 77G may vary linearly in moving from the center of the slit at the apex of the truncated spherical protrusion to either extreme of the slit 80, which may be roughly 0.150 to 0.170 inches long altogether. Therefore, the thickness of the diaphragm wall 77 at the apex is preferably 0.015±0.002. Also, the apex of the outer surface 78 may also protrude downward from the cylindrical support wall by 0.048±0.005 inches. These proportions serve to provide both the requisite rigidity to maintain pressure in the casing interior 20, by reacting the pressure forces generated therefrom as hoop compression stresses to engender its self sealing nature (FIG. 2B—the pressure in the casing 10 creates a reaction force on each side of the slit, tending to cause the slit 80 to remain closed), and the proportions provide the necessary flexibility to allow transmission of air (FIG. 2A).

The thickness gradient also accommodates both the air flow from small pressure changes generated by the bulb (FIG. 2A), which may result primarily in air flow through the region of the slit being close to the wall's apex, and larger air flows from higher pressure changes from rapidly and forcefully depressing the resilient bulb 40. Such larger forces could cause shearing at the edge of the slit, resulting in a failure in the ability of the valve to maintain the required pressure differences. By varying the thickness gradient linearly across the slit, from its center to its extreme, and by balancing the diameter of the inner truncated spherical surface and its position relative to the outer truncated spherical surface, the diaphragm valve may both accommodate small air flows from small pressure differentials with the slit primarily only opening in the region proximate to the center of the slit, and larger ones because the larger forces will tend to thereby open more of the slit. The wall thickness at the outer extremes of the slit 80 may thus be set so that the maximum pressure and air flow that may be generated by the resilient bulb will be unable to open the slit all the way to those extreme edges, thereby preventing failure of the resilient diaphragm valve at the extremes of the slit. This may become more important where, as illustrated in FIG. 2A, the casing 10 may be split, proximate to the valve, into two pieces that may be secured together by corresponding male and female threading 20, to permit removal of the upper portion for refilling of the viscous substance. In this case, the pressure cycling that the slit may receive due to the extended industrial use of the marker (as opposed to typical use of a disposable marker by the ordinary consumer) may cause fatiguing and failure of the valve at the ends of the slit 80.

The marking pen 5 with the self-sealing slit 80 in the stand-alone diaphragm valve 70 may support an amount of pressurization being sufficient to force the flow of a liquid from the marker tip 30, where the liquid or semi-paste has a viscosity being in the range of approximately 1200 to approximately 10,000 centipoises. Lab testing has showed that to open the slit 80, for delivery of air in order to pressurize interior cavity 20 of the casing 10, requires approximately 0.5 to 1.0 psi, while the valve may withstand the pressures contained within the cavity for up to approximately 5 psi to 6 psi, before the slit 80 opens to allow leakage of the air therefrom. This ability to withstand the back pressure through hoop compression stress is quite high, as this leakage would have required a user to have been pumping the resilient bulb 40 dozens of times to reach this pressure level, especially with a partially used marking pen (very little remaining substance in the casing).

The results obtained with the stand-alone diaphragm valve 70 of the present invention represent a significant improvement over the prior art devices, in terms of the length of time that the valve maintains pressure in the casing cavity 20, once having been pressurized using the bulb member 40. Recent testing has shown a prior art marker to be substantially usable for approximately 1 hour after pumping, while comparable testing of a marker of the present invention using a prototype of the valve disclosed herein, has demonstrated immediate off-the-shelf usability for a period of 2 months. The reason for such improved performance becomes apparent by a comparison of the prior art that is illustrated in FIGS. 1A and 1B, with the diaphragm valve of the present invention, as seen, for example, in FIG. 2B. The prior art utilizes valves that comprise flat disk-shaped members, and over the coarse of time, the slit naturally tends to be forced open due to creep deformation that results from the stress caused by the pressure being contained. This creep deformation permits the air that had been pumped into the chamber containing the viscous substance to escape. Conversely, because of the curved shape of the diaphragm valve of the current invention, as seen in FIG. 2B, the constant pressure along the curved valve surface is reacted with a force on each side of the slit, causing one side one the slit into bearing contact with the opposite side of the slit, forming a self-sealing arrangement that is not similarly subject to creep deformation and leakage.

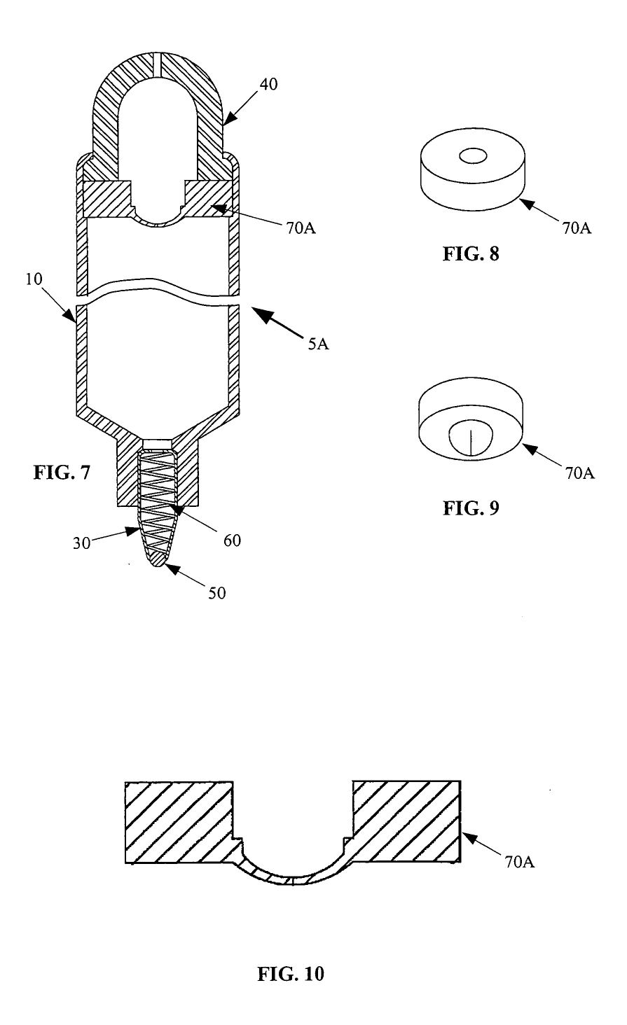

Alternate embodiments of the stand-alone diaphragm valve are shown by the valve 70A in FIGS. 7-10, and the valve 70B in FIG. 11-12. The valve 70A may be formed the same as valve 70, except that it does not have the secondary cylinder 73 to provide support for the inside surface 47 of the bulb member 40. The valve 70A embodiment is simpler, but nonetheless permits functioning of the marking pen as previously described. The valve 70B has a secondary cylinder 47B, but the cylinder extends from the periphery of the support wall, and serves to create a cavity into which the resilient bulb member may be received to provide for greater bulb deformations and greater amounts of air being transmitted per stroke. The cylinder 47B may have an annular protrusion 47C to accommodate installation within casing 10.

The examples and descriptions provided merely illustrate a preferred embodiment of the present invention. Those skilled in the art and having the benefit of the present disclosure will appreciate that further embodiments may be implemented with various changes within the scope of the present invention. Other modifications, substitutions, omissions and changes may be made in the design, size, materials used or proportions, operating conditions, assembly sequence, or arrangement or positioning of elements and members of the preferred embodiment without departing from the spirit of this invention.

We claim:

1. A hand-held marking pen for applying a liquid or semi-paste substance on a surface, said marking pen comprising:
a hollow casing with a dispensing orifice at one end;
a ball being spring biased within said casing to move from a position being distal from said orifice to a position proximal to and blocking said orifice;
a flexible bulb member with an orifice therein, said flexible bulb member being fixed to a second end of said casing, said flexible bulb member permitting finger actuated pressurization of an interior of said casing;
a valve being positioned between the liquid or semi-paste substance and said flexible bulb member, said valve serving to maintain air under pressure on the downstream side of said valve to ensure good flow of the substance when said ball is moved against said biasing to said distal position during use, said valve comprising a stand-alone diaphragm valve, said stand-alone diaphragm valve comprising:
a support wall with a cylindrical recess therein;
a dome-shaped diaphragm wall being integrally formed with said support wall; said dome-shaped diaphragm wall comprising an outer surface and an inner surface; said outer surface comprising a truncated spherical surface having an axis being collinear with said axis of said cylindrical recess; said inner surface comprising a truncated spherical surface having an axis being generally collinear with said axis of said outer surface; said cylindrical recess terminating on said truncated spherical inner surface; said inner truncated spherical surface being non-concentric with said truncated spherical outer surface to produce thinning of said diaphragm wall at an apex therein;
a self-sealing slit formed in said diaphragm wall; said slit comprising a length being generally centered with respect to said axis of said diaphragm wall; and
wherein said self-sealing slit of said diaphragm valve permits pressurized air flow in one direction being out through said self-sealing slit from said inner surface to said outer surface; and wherein said self-sealing slit of said diaphragm valve generally prohibits return pressurized air flow in the opposite direction, being in through said self-sealing slit from said outer surface to said inner surface.

2. A hand-held marking pen according to claim 1 wherein said opposite direction flow being prohibited by said self-sealing slit is by said dome-shaped diaphragm wall on a first side of said slit and said dome-shaped diaphragm wall on a second side of said slit resisting said pressure by bearing against each other to accomplish said self-sealing, with said pressure being reacted through compressive hoop stress within said dome-shaped diaphragm wall.

3. A hand-held marking pen according to claim 2 wherein said thinning of said dome-shaped diaphragm wall produces an opening in said self-sealing slit during said pressurized flow in said one direction to result in non-linear displacement along said slit, with maximum displacement occurring in a portion of said slit at said apex of said dome-shaped diaphragm wall.

4. A hand-held marking pen according to claim 3 wherein said self-sealing slit in said diaphragm wall supports an amount of said pressurization being sufficient to force flow of the substance having a viscosity in the range of approximately 1200 to approximately 10,000 centipoises.

5. A hand-held marking pen according to claim 4 wherein when said valve is formed of a resilient material and wherein when said thinning of said diaphragm wall at said apex is approximately down to 0.015 inches, said self-sealing slit in said diaphragm wall permits said pressurized air flow in through said self-sealing slit from said inner surface to said outer surface for pressures being approximately 0.5 to 1.0 psi, and prohibits said return pressurized air flow through said self-sealing slit from said outer surface to said inner surface for pressures being up to approximately 5 psi to 6 psi.

6. A hand-held marking pen according to claim 6 wherein said self-sealing slit resists said pressure for a period of at least two months.

7. A hand-held marking pen according to claim 5 wherein said resilient material is from the group of resilient materials consisting of: high density polyethylene; low density polyethylene; linear low density polyethylene; ultra-low density polyethylene; and DuPont Hytrel.

8. In a device for applying a liquid or semi-paste substance, wherein said device comprises a casing with an orifice in a dispensing tip, a ball being spring biased to selectively plug and unplug said orifice to permit flow of the substance, a flexible bulb member with an orifice therein permitting repeatable finger actuated pressurization of an interior of said casing, and a valve positioned between the liquid or semi-paste substance in said casing and said flexible bulb member, said valve maintaining on the downstream side of said valve, air under pressure to ensure good flow of the substance, wherein the improvement comprises:
said valve comprising a stand-alone diaphragm valve, said stand-alone diaphragm valve comprising:
a support wall with a cylindrical recess therein;
a dome-shaped diaphragm wall being integrally formed with said support wall; said dome-shaped diaphragm wall comprising an outer surface and an inner surface; said outer surface comprising a truncated spherical surface having an axis being collinear with said axis of said cylindrical recess; said inner surface comprising a truncated spherical surface having an axis being generally collinear with said axis of said outer surface; said cylindrical recess terminating on said inner surface; said inner truncated spherical surface being non-concentric with said outer surface to produce thinning of said diaphragm wall at an apex therein;
a self-sealing slit formed in said diaphragm wall; said slit comprising a length being generally centered with respect to said axis of said diaphragm wall; and
wherein said self-sealing slit of said diaphragm valve permits pressurized air flow in one direction being out through said self-sealing slit from said inner surface to said outer surface; and wherein said self-sealing slit of said diaphragm valve generally prohibits pressurized air flow in the opposite being in through said self-sealing slit from said outer surface to said inner surface.

9. A device according to claim 8 wherein said opposite direction flow being prohibited by said self-sealing slit is by said dome-shaped diaphragm wall on a first side of said slit and said dome-shaped diaphragm wall on a second side of said slit resisting said pressure by bearing against each other to accomplish said self-sealing, with said pressure being reacted through compressive hoop stress within said dome-shaped diaphragm wall.

10. A device according to claim 9 wherein said thinning of said dome-shaped diaphragm wall produces an opening in said self-sealing slit during said pressurized flow in said one direction to result in non-linear displacement along said slit, with maximum displacement occurring in a portion of said slit at said apex of said dome-shaped diaphragm wall.

11. A device according to claim 10 wherein said self-sealing slit in said diaphragm wall supports an amount of said pressurization being sufficient to force flow of the substance having a viscosity in the range of approximately 1200 to approximately 10,000 centipoises.

12. A device according to claim 11 wherein when said valve is formed of a resilient material and wherein when said thinning of said diaphragm wall at said apex is approximately down to 0.015 inches, said self-sealing slit in said diaphragm wall permits said pressurized air flow in through said self-sealing slit from said inner surface to said outer surface for pressures being approximately 0.5 to 1.0 psi, and prohibits said return pressurized air flow through said self-sealing slit from said outer surface to said inner surface for pressures being up to approximately 5 psi to 6 psi.

13. A device according to claim 12 wherein said self-sealing slit resists said pressure for a period of at least two months.

14. A device according to claim 13 wherein said resilient material is from the group of resilient materials consisting of: high density polyethylene; low density polyethylene; linear low density polyethylene; ultra-low density polyethylene; and DuPont Hytrel.

15. A diaphragm valve comprising:
a support wall with a cylindrical recess therein;
a dome-shaped diaphragm wall being formed integral with said support wall; said dome-shaped diaphragm wall comprising an outer surface and an inner surface; said outer surface comprising a truncated spherical surface having an axis being generally collinear with said axis of said cylindrical recess; said inner surface comprising a truncated spherical surface having an axis being generally collinear with said axis of said outer surface; said cylindrical recess terminating on said inner surface of said diaphragm wall; said inner truncated spherical surface being non-concentric with said outer surface to produce thinning of said diaphragm wall at an apex of said diaphragm wall;
a self-sealing slit formed in said diaphragm wall; said slit comprising a length being generally centered with respect to said axis of said truncated spherical surface; and
wherein said self-sealing slit of said diaphragm valve permits pressurized air flow in one direction being out through said self-sealing slit from said inner surface to said outer surface; and
wherein said self-sealing slit of said diaphragm valve generally prohibits pressurized air flow in the opposite direction being in through said self-sealing slit from said outer surface to said inner surface.

16. A diaphragm valve according to claim 15 wherein said opposite direction flow being prohibited by said self-sealing slit is by said dome-shaped diaphragm wall on a first side of said slit and said dome-shaped diaphragm wall on a second side of said slit resisting said pressure by bearing against each other to accomplish said self-sealing, with said pressure being reacted through compressive hoop stress within said dome-shaped diaphragm wall.

17. A diaphragm valve according to claim 16 wherein said thinning of said dome-shaped diaphragm wall produces an opening in said self-sealing slit during said pressurized flow in said one direction to result in non-linear displacement along said slit, with maximum displacement occurring in a portion of said slit at said apex of said dome-shaped diaphragm wall.

18. A diaphragm valve according to claim 17 wherein said self-sealing slit in said diaphragm wall supports an amount of said pressurization being sufficient to force flow of the substance having a viscosity in the range of approximately 1200 to approximately 10,000 centipoises.

19. A diaphragm valve according to claim 18 wherein when said valve is formed of a resilient material and wherein when said thinning of said diaphragm wall at said apex is approximately down to 0.015 inches, said self-sealing slit in said diaphragm wall permits said pressurized air flow in through said self-sealing slit from said inner surface to said outer surface for pressures being approximately 0.5 to 1.0 psi, and prohibits said return pressurized air flow through said self-sealing slit from said outer surface to said inner surface for pressures being up to approximately 5 psi to 6 psi.

20. A diaphragm valve according to claim 19 wherein said self-sealing slit resists said pressure for a period of at least two months.

21. A diaphragm valve according to claim 20 wherein said resilient material is from the group of resilient materials consisting of: high density polyethylene; low density polyethylene; linear low density polyethylene; ultra-low density polyethylene; and DuPont Hytrel.
